(19) United States
(12) Patent Application Publication
(10) Pub. No.: US 2025/0239262 A1
(43) Pub. Date: Jul. 24, 2025

(54) VOICE PROCESSING SYSTEM, VOICE PROCESSING METHOD, AND RECORDING MEDIUM IN WHICH VOICE PROCESSING PROGRAM IS RECORDED

(71) Applicant: SHARP KABUSHIKI KAISHA, Sakai City (JP)

(72) Inventors: Hiromasa NABETANI, Sakai City (JP); Satoshi TERADA, Sakai City (JP)

(21) Appl. No.: 19/019,056

(22) Filed: Jan. 13, 2025

(30) Foreign Application Priority Data
Jan. 23, 2024 (JP) 2024-007857

(51) Int. Cl. G10L 17/06

(52) U.S. Cl. CPC G10L 17/06

(57) ABSTRACT

A voice processing system includes an acquisition processing unit that acquires voices uttered by users and input to respective microphones of a plurality of audio devices arranged in the same space, a determination processing unit that determines a degree of similarity among a respective plurality of voices acquired from the plurality of audio devices, and an output processing unit that outputs a specific first voice from among the plurality of voices to a voice recognition processing unit and a voice synthesis processing unit in a case where the degree of similarity among the plurality of voices is equal to or greater than a threshold value.

### INCORPORATION BY REFERENCE

This application is based upon and claims the benefit of priority from the corresponding Japanese Patent Application No. 2024-007857 filed on Jan. 23, 2024, the entire contents of which are incorporated herein by reference.

### BACKGROUND

The present disclosure relates to a technique for controlling voices when a plurality of users individually use audio devices to have conversations.

In the related art, a known technique converts a voice uttered by a user into text information and displaying the text information. For example, a known meeting system can summarize, per predetermined section of a meeting, meeting text information including text information obtained from utterance contents of meeting participants and sequentially displaying the summary results.

Here, in one meeting room, a plurality of users may hold a meeting by using respective audio devices. In a case where a plurality of audio devices are used in the same space, a voice uttered by one user may be input to microphones of the plurality of audio devices. Then, disadvantageously, the accuracy of voice processing may decrease due to generation of a plurality of pieces of text information for the same uttered voice, synthesis processing of the same uttered voice, or the like.

### SUMMARY

An object of the present disclosure is to provide a voice processing system, a voice processing method, and a recording medium in which a voice processing program is recorded that are capable of improving accuracy of voice processing in a case where conversations are made using a plurality of audio devices in the same space.

A voice processing system according to an aspect of the present disclosure includes an acquisition processing unit, a determination processing unit, an output processing unit, and a display processing unit. The acquisition processing unit acquires voices uttered by users and input to respective microphones of a plurality of audio devices arranged in the same space. The determination processing unit determines a degree of similarity among a respective plurality of voices acquired from the plurality of audio devices. The output processing unit outputs a specific first voice from among the plurality of voices to a voice processing unit in a case where a degree of similarity among the plurality of voices is equal to or greater than a threshold value.

Another aspect of the present disclosure provides a voice processing method executed by one ore plurality of processors including acquiring voices uttered by users and input to respective microphones of a plurality of audio devices arranged in a same space, determining a degree of similarity among a respective plurality of voices acquired from the plurality of audio devices, and outputting a specific first voice from among the plurality of voices to a voice processing unit in a case where the degree of similarity among the plurality of voices is equal to or greater than a threshold value.

Another aspect of the present disclosure provides a non-transitory computer-readable recording medium in which a voice processing program is recorded for causing one or more processors to acquire voices uttered by users and input to respective microphones of a plurality of audio devices arranged in the same space, determine a degree of similarity among a respective plurality of voices acquired from the plurality of audio devices, and output a specific first voice from among the plurality of voices to a voice processing unit in a case where the degree of similarity among the plurality of voices is equal to or greater than a threshold value.

According to the present disclosure, a voice processing system, a voice processing method, and a recording medium in which a voice processing program is recorded can be provided that are capable of improving the accuracy of voice processing in a case where conversations are made using a plurality of audio devices in the same space.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram illustrating an applied example of a meeting assistance system according to an embodiment of the disclosure.

FIG. 2 is a block diagram illustrating a configuration of the meeting assistance system according to an embodiment of the disclosure.

FIG. 3 is a table illustrating an example of information of equipment utilized in the meeting assistance system according to the embodiment of the disclosure.

FIG. 4 is a table illustrating an example of utterance information utilized in the meeting assistance system according to the embodiment of the disclosure.

FIG. 5 is a table illustrating an example of summary information utilized in the meeting assistance system according to the embodiment of the disclosure.

FIG. 6 is a table illustrating an example of agenda information utilized in the meeting assistance system according to the embodiment of the disclosure.

FIG. 7A is a diagram illustrating an example of a setting screen displayed in the meeting assistance system according to the embodiment of the present disclosure.

FIG. 7B is a diagram illustrating an example of the setting screen displayed in the meeting assistance system according to the embodiment of the present disclosure.

FIG. 8 is a diagram illustrating an example of a meeting screen displayed in the meeting assistance system according to the embodiment of the present disclosure.

FIG. 9 is a diagram illustrating an example of the meeting screen displayed in the meeting assistance system according to the embodiment of the present disclosure.

FIG. 10 is a diagram illustrating an example of the meeting screen displayed in the meeting assistance screen according to the embodiment of the present disclosure.

FIG. 11 is a diagram illustrating an example of the meeting screen displayed in the meeting assistance screen according to the embodiment of the present disclosure.

FIG. 12 is a diagram illustrating an example of the meeting screen displayed in the meeting assistance screen according to the embodiment of the present disclosure.

FIG. 13 is a diagram illustrating an example of the meeting screen displayed in the meeting assistance screen according to the embodiment of the present disclosure.

FIG. 14 is a diagram illustrating an example of the meeting screen displayed in the meeting assistance screen according to the embodiment of the present disclosure.

FIG. 15 is a diagram illustrating an example of the meeting screen displayed in the meeting assistance screen according to the embodiment of the present disclosure.

FIG. 16 is a diagram illustrating an example of the meeting screen displayed in the meeting assistance screen according to the embodiment of the present disclosure.

FIG. 17 is a block diagram illustrating another configuration of a meeting assistance device according to the embodiment of the disclosure.

FIG. 18 is a flowchart illustrating an example of a procedure of meeting assistance processing executed in the meeting assistance device according to the embodiment of the present disclosure.

FIG. 19 is a flowchart illustrating an example of the procedure of the meeting assistance processing executed in the meeting assistance device according to the embodiment of the present disclosure.

### DETAILED DESCRIPTION

Embodiments of the disclosure will be described below with reference to the drawings. Note that the following embodiments are specific examples of the disclosure, and do not limit the technical scope of the disclosure.

An information processing system according to the present disclosure can be applied to, for example, a case where a plurality of users in the same space (for example, a meeting room) have conversations (meeting) with users in other spaces by using respective audio devices each including a microphone and an utterer. Note that the information processing system can also be applied to a case where a plurality of users have conversations using respective audio devices in one space. Furthermore, the information processing system can also be applied to a case where one user in one space uses an audio device to have a conversation with a user in another space.

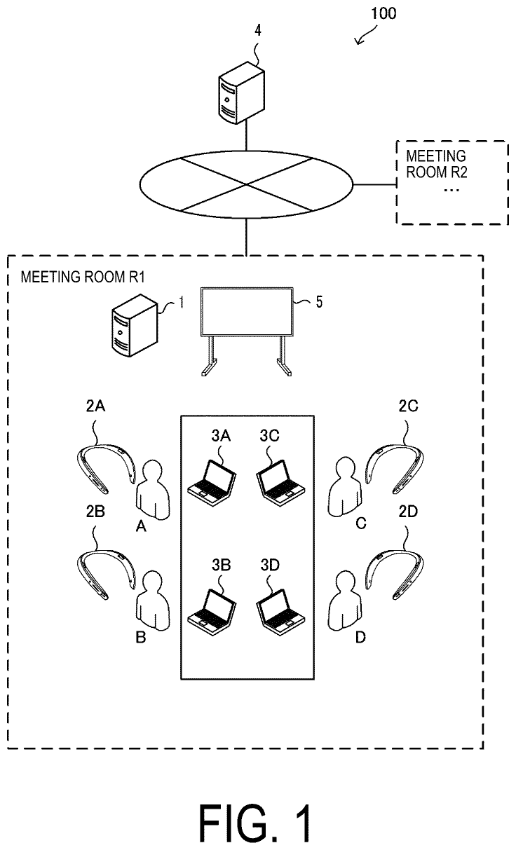

FIG. 1 is a diagram illustrating an applied example of a meeting assistance system 100 according to the present embodiment. As illustrated in FIG. 1, users A to D participate in a meeting in a meeting room R1, and other users (not illustrated) participate in the meeting in a meeting room R2. The users A to D respectively have conversations using neckband-type audio devices 2A to 2D that can be worn on the neck. The users in the meeting room R2 may use audio devices 2, or may use one microphone utterer device installed in the meeting room R2. Note that, although FIG. 1 illustrates an example in which each of the users A to D uses the audio device 2, there is no limitation thereto, and some of the users may exclusively use the audio device 2. The meeting assistance system 100 is an example of an information processing system and a voice processing system of the present disclosure.

Each of the audio devices 2 in the meeting room R1 is wirelessly connected (connected by Bluetooth (registered trade mark)) to the meeting assistance device 1. A voice input to the microphone of each of the audio devices 2 is input to a meeting assistance device 1 and is transmitted from the meeting assistance device 1 to a meeting terminal 3. A meeting application of a meeting server 4 transmits, to the meeting room R2, the voice received by the meeting terminal 3. Thus, the voice in the meeting room R1 is output (reproduced) from the utterer of the audio device 2 (or the microphone utterer device) of the user in the meeting room R2. Similarly, the meeting application of the meeting server 4 reproduces, through the utterer of the audio device 2 of each user in the meeting room R1, the voice input to the microphone of the audio device 2 (or the microphone utterer device) in the meeting room R2.

As described above, the meeting assistance system 100 is a system that enables a plurality of users to have conversations in the same space (the meeting room R1 in FIG. 1) by individually using the audio device 2. The meeting assistance system 100 may include a display device 5 that can be used in a meeting. The meeting application displays, on the display device 5, meeting information such as camera images of the meeting participants and meeting materials, and recognition results (text information) acquired by converting voices into text by voice recognition processing.

As illustrated in FIG. 1, the meeting assistance system 100 includes the meeting assistance device 1, the audio devices 2, the meeting terminal 3, and the meeting server 4. The audio device 2 is wireless connection-based audio equipment equipped with a microphone and an utterer. Note that the audio device 2 may include, for example, a function such as an AI utterer or a smart utterer. The meeting assistance system 100 is a system that includes a plurality of audio devices 2 and transmits and receives audio data of uttered voices of users to and from the plurality of audio devices 2. The audio devices 2 may be audio devices of the same type or of different types. For example, the plurality of audio devices 2 may include wireless connection-based audio devices and wired connection-based audio devices. The plurality of audio devices 2 may include neckband type audio devices, headset type audio devices, and stationary audio devices.

The meeting assistance device 1 controls voices (input voices, output voices, and the like) to and from the audio devices 2, and executes processing of transmitting and receiving voices to and from the plurality of audio devices 2 when a meeting is started in a meeting room, for example. For example, the meeting assistance device 1 controls a plurality of audio devices 2 arranged in the same space. The meeting assistance device 1 accumulates voices acquired from the audio devices 2 as recording voices and executes processing (voice recognition processing) of converting the acquired voices into text. Note that the meeting assistance device 1 alone may constitute the information processing system and the voice processing system of the present disclosure.

The information processing system of the present disclosure may include a function of providing various services such as a meeting service, a caption (transcription) service by voice recognition, a translation service, and a minutes service. In the present embodiment, the meeting assistance system 100 includes the meeting server 4 that provides the meeting service. The meeting server 4 provides an online meeting service of the meeting application which is general-purpose software. For example, the meeting application is installed in the meeting terminal 3. Activating the meeting terminal 3 for login enables execution of an online meeting (for example, an online meeting in the meeting room R1 and the meeting room R2) utilizing the meeting application.

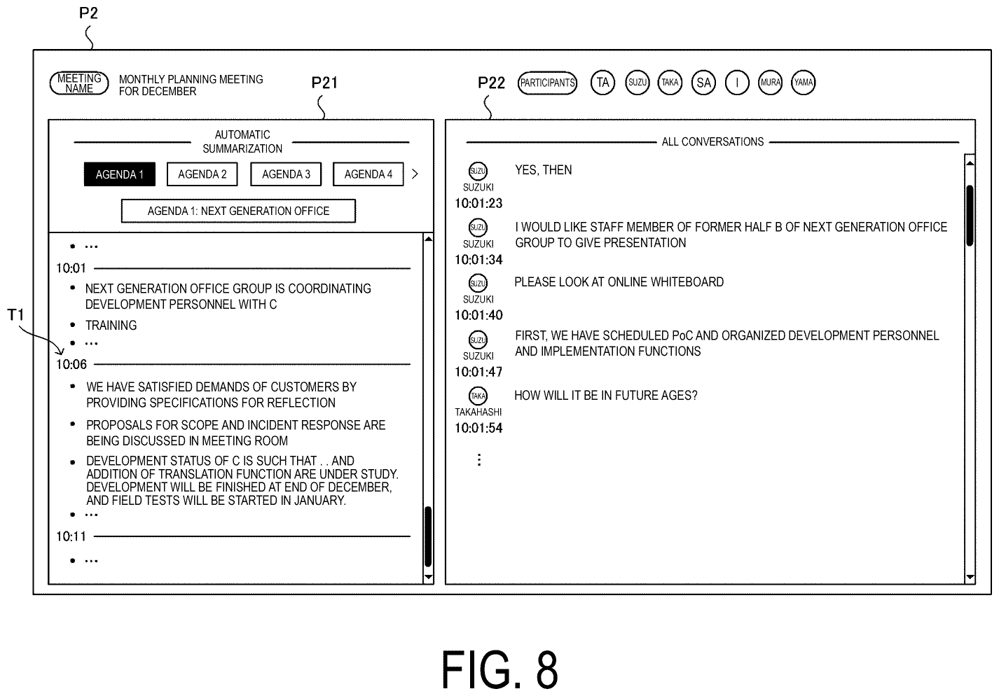

The meeting terminal 3 may be, for example, a user terminal used by a representative user (organizer) who organizes the meeting among the users who participate in the meeting. For example, the user device 3A of the user A who is the organizer functions as the meeting terminal 3. In this case, the users B to D can activate the meeting application on the user terminals 3B to 3D and view a meeting screen P2 (FIG. 8 and the like).

### Conference Assistance Device 1

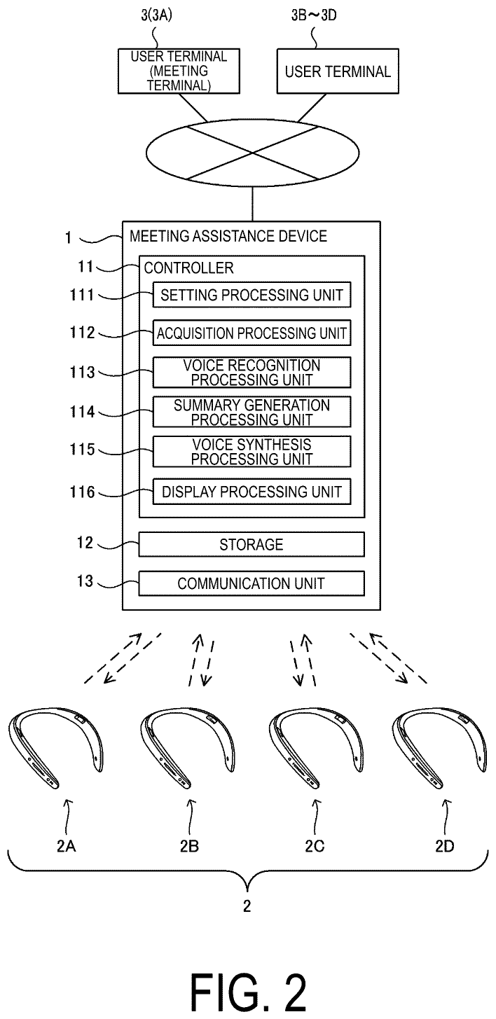

As illustrated in FIG. 2, the meeting assistance device 1 is equipment including a controller 11, a storage 12, a communication unit 13, and the like. For example, the meeting assistance device 1 is connected to the plurality of audio devices 2, and includes a function of mixing or splitting voices received from the plurality of audio devices 2 or the meeting terminal 3, a voice recognition function of converting input voices into text information, and the like.

The communication unit 13 is used to connect the meeting assistance device 1 to a communication network in a wired or wireless manner and to execute data communication with external equipment such as the audio devices 2, the meeting terminal 3, the display devices 5, and the like via the communication network in accordance with a predetermined communication protocol. For example, the communication unit 13 executes pairing processing in accordance with the Bluetooth scheme to wirelessly connect to each audio device 2.

The storage 12 is a non-volatile storage such as a hard disk drive (HDD), a solid state drive (SSD), or a flash memory that stores various types of information. The storage 12 stores equipment information D1 related to the audio devices 2, utterance information D2 related to utterance contents, summary information D3 related to summary sentences, and agenda information D4 related to agendas.

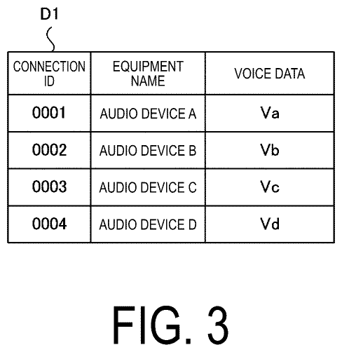

FIG. 3 illustrates an example of the equipment information D1. In the equipment information D1, information such as a connection ID, an equipment name, and voice data is registered. The connection ID is identification information (equipment information) utilized when the audio device 2 is connected, and is, for example, a Bluetooth address. The equipment name is an equipment name of the audio device 2. The voice data is data of a voice (uttered voice) acquired from the audio device 2. As described above, the voice information is stored in the equipment information D1 for each piece of equipment. Each audio data is assigned identification information of the equipment (audio device 2) and stored.

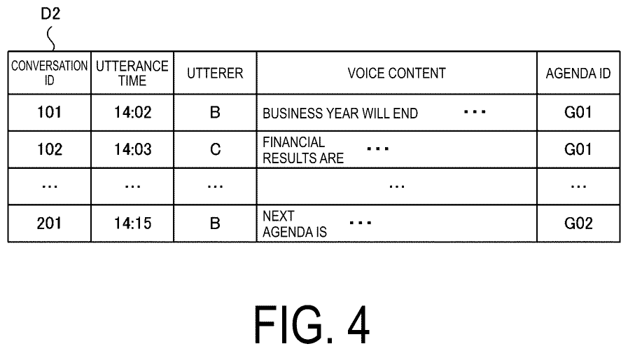

FIG. 4 illustrates an example of utterance information D2. In the utterance information D2, information such as a conversation ID, utterance time, an utterer, an utterance content, and an agenda ID is registered. The conversation ID is identification information of an utterance content of a user (utterer). The utterance time is a time at which the user issued an utterance. The utterer is the name of the user or the identification information thereof (user ID). The utterance content is character information obtained by converting a voice uttered by the user into text information. The agenda ID is identification information of an agenda of the meeting. When a meeting related to a predetermined agenda is started, the controller 11 registers each piece of information in the utterance information D2 based on an uttered voice of the user acquired from the audio device 2.

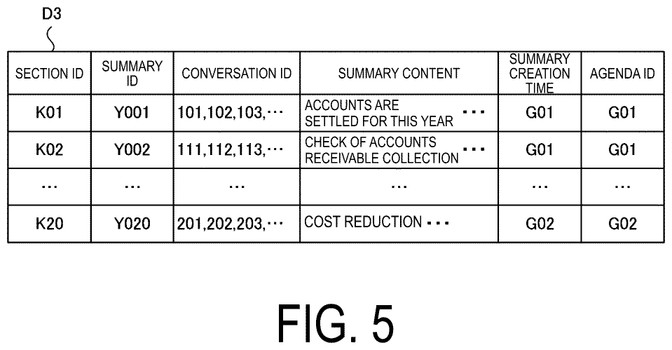

FIG. 5 illustrates an example of summary information D3. In the summary information D3, information such as a section ID, a summary ID, a conversation ID, a summary content, a summary creation time, and an agenda ID is registered. The section ID is identification information that can identify sections into which the meeting is divided according to a predetermined time or a predetermined number of characters (details of the sections will be described later). The summary ID is identification information that can identify a summary sentence generated based on text information into which a voice has been converted (details of the summary sentence will be described later). The summary content is the content of the summary sentence, and the summary creation time is the time at which the summary is created. The controller 11 generates a summary sentence based on a voice uttered by the user during the meeting and registers each piece of information in the summary information D3.

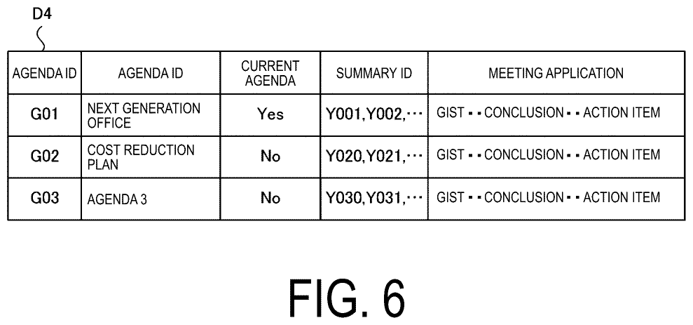

FIG. 6 illustrates an example of the agenda information D4. In the agenda information D4, information such as an agenda ID, an agenda name, a current agenda, a summary ID, and post-meeting summary data is registered. The agenda name is the name of an agenda. The current agenda is information indicating whether the current agenda is the agenda for the conversations (the meeting) currently in progress. FIG. 6 illustrates that a meeting is currently in progress for an agenda related to a “next generation office”. The post-meeting summary data indicates data (minutes data) generated after the end of the meeting, and includes, for example, contents related to minutes such as a gist, a conclusion, and an action item (a future policy or the like). For example, when a meeting is started for an agenda specified by a meeting organizer, the controller 11 registers each piece of information in the agenda information D4 based on the uttered voice of the user acquired from the audio device 2, and when the meeting is ended, the controller 11 registers the post-meeting summary data in the agenda information D4.

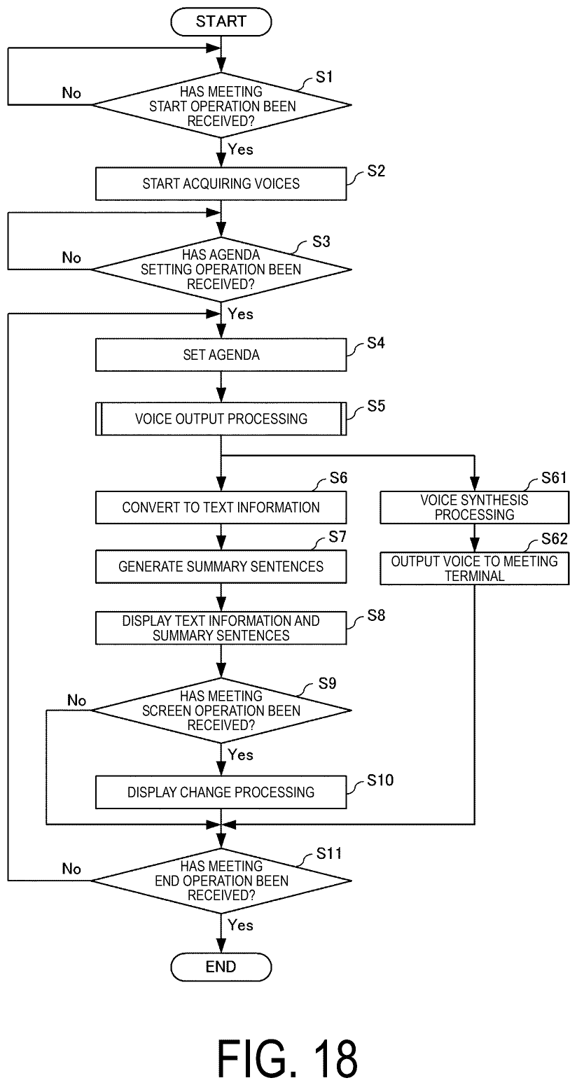

The storage 12 stores a control program such as a meeting assistance program (an example of the information processing program of the present disclosure) for causing the controller 11 to execute meeting assistance processing described below (see FIG. 18). For example, the meeting assistance program may be non-transitorily recorded in a computer-readable recording medium such as a CD or a DVD, read by a reading device (not illustrated) such as a CD drive or a DVD drive included in the user terminal 1, and stored in the storage 12.

The controller 11 includes control devices such as a central processing unit (CPU), a read only memory (ROM), and a random access memory (RAM). The CPU is a processor that executes various types of arithmetic processing. The ROM is non-volatile storage that stores, in advance, control programs such as a basic input/output system (BIOS) and an operating system (OS) for causing the CPU to execute various types of calculation processing. The RAM is a volatile or non-volatile storage that stores various types of information and is used as a temporary storage memory (work area) for the various types of processing executed by the CPU. Then, the controller 11 controls the meeting assistance device 1 by causing the CPU to execute various types of the control programs stored in advance in the ROM or the storage 12.

Specifically, as illustrated in FIG. 2, the controller 11 includes various processing units such as a setting processing unit 111, an acquisition processing unit 112, a voice recognition processing unit 113, a summary generation processing unit 114, a voice synthesis processing unit 115, and a display processing unit 116. Note that the controller 11 functions as the various types of processing units by executing various types of processing in accordance with the control program using the CPU. Further, some or all of the processing units may be constituted by an electronic circuit. Note that the control programs may be programs for causing multiple processors to function as the processing units.

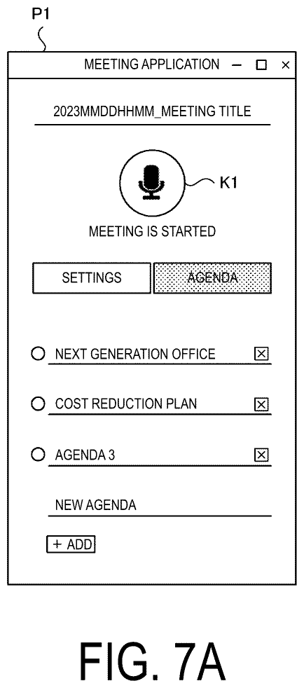

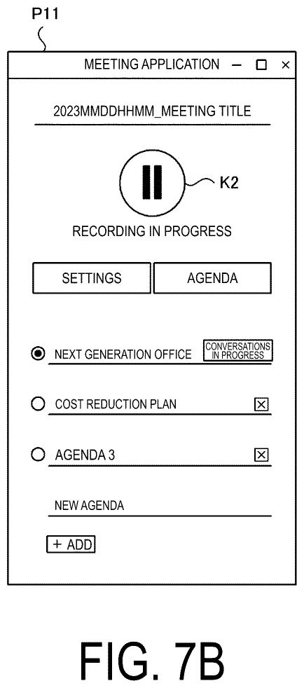

The setting processing unit 111 sets agendas of conversations (meeting). Specifically, the setting processing unit 111 receives, from a user (a meeting organizer or the like), an operation of registering a new agenda, an operation of selecting an agenda, an operation of changing the agenda for the conversations currently in progress, and the like). For example, the user A who is the organizer of the meeting activates the meeting application on the user device 3A (meeting terminal 3) to display a setting screen P1 (see FIG. 7A). The user A can register one or more agendas by selecting an “Agenda” field on the setting screen P1. The user A selects one agenda from a plurality of registered agendas on the setting screen P1. FIG. 7B illustrates an example of a setting screen P11 displayed after the meeting is started (during the meeting). FIG. 7B displays identification information (“conversations are in progress”) indicating the agenda (for example, the “next generation office”) for the conversations currently in progress. In a case of changing the agenda, the user A selects another agenda on the setting screen P1. The user A can select a “Setting” field on the setting screen P1 to select users who participants in the meeting or select the audio device 2 to be used in the meeting.

Upon setting the agenda in accordance with a user operation, the setting processing unit 111 registers, in the agenda information D4 (see FIG. 6), the identification information of the agenda (agenda ID) and the agenda name. When the meeting is started, the setting processing unit 111 registers, in the agenda information D4, information (“Yes”) that can identify the agenda of the meeting (here, the “next generation office”).

Note that the setting processing unit 111 may allow only a user having a predetermined authority to perform the operations of setting the agenda and starting the meeting. As another embodiment, the setting processing unit 111 may automatically set or change the agenda by analyzing the utterance contents of the users.

The acquisition processing unit 112 acquires a voice uttered by the user. Specifically, when the meeting is started and the user issues an utterance, the acquisition processing unit 112 acquires the uttered voice input to the microphone of the audio device 2 of the user. The acquisition processing unit 112 acquires time information corresponding to the utterance time of the uttered voice of the user. For example, the acquisition processing unit 112 acquires the time at which the uttered voice of the user is input to the microphone of the audio device 2 or the time at which the uttered voice is acquired.

Upon acquiring the voice from the audio device 2, the acquisition processing unit 112 stores the voice data in the equipment information D1 (see FIG. 3) in association with the identification information of the audio device 2 (connection ID, equipment name, etc.). In the example illustrated in FIG. 1, the acquisition processing unit 112 acquires, from the audio devices 2, the voices of the users A to D in the meeting room R1, and stores the voices in the equipment information D1 in association with the connection ID.

Based on the voice acquired by the acquisition processing unit 112, the voice recognition processing unit 113 executes voice recognition processing of converting the voice into text. The voice recognition processing unit 113 converts the voice into text information by using a predetermined voice recognition engine (learned model). Note that the voice recognition engine is generated by learning, for example, various voice data (teacher data). The meeting assistance device 1 is equipped with the voice recognition engine. Note that the voice recognition processing unit 113 may execute voice processing such as echo cancellation, noise cancellation, and gain adjustment on the voice acquired by the acquisition processing unit 112.

The voice recognition processing unit 113 registers the text information in the utterance information D2 (see FIG. 4) as an utterance content. The voice recognition processing unit 113 registers the identification information (conversation ID) of the utterance content, the time information (utterance time), and the identification information (name) of the utterer in association with the utterance content. The voice recognition processing unit 113 registers the identification information (agenda ID) of the agenda corresponding to the utterance content in association with the utterance content. The voice recognition processing unit 113 registers the agenda ID of the agenda set by the setting processing unit 111 in association with the utterance content. The voice recognition processing unit 113 is an example of the conversion processing unit of the present disclosure.

Based on the text information to be converted by the voice recognition processing unit 113, the summary generation processing unit 114 generates a summary sentence in a short sentence format that summarizes the utterance content of the user. The summary generation processing unit 114 generates summary sentences from the text information by using the predetermined summary generation engine (learned model). Note that the summary generation engine is generated by learning, for example, various conversation data and summary data (teacher data). The meeting assistance device 1 is equipped with the summary generation engine. For example, the summary generation processing unit 114 generates one summary sentence from a plurality of pieces of text information corresponding to uttered voices of one or a plurality of users.

The summary generation processing unit 114 generates summary sentences for each predetermined section. Specifically, the summary generation processing unit 114 generates one or more summary sentences at predetermined time intervals (for example, every five minutes) or for every predetermined number of characters (for example, 1500 characters) of the text information.

The summary generation processing unit 114 also registers the summary sentences in the summary information D3 (see FIG. 5) as a summary content. The summary generation processing unit 114 registers the identification information of the section (section ID), the identification information of the summary sentences (summary IDs), and the identification information of the conversations corresponding to the text information (conversation IDs) in association with the summary contents. The summary generation processing unit 114 registers the time when the summary sentences are generated in association with the summary contents. The summary generation processing unit 114 registers the agenda ID of the agenda set by the setting processing unit 111 in association with the summary contents. In the example illustrated in FIG. 5, conversations corresponding to a plurality of pieces of text information and having conversation IDs “101”, “102”, “103”, . . . are made in a section with a section ID “K01”, and one summary (summary ID “Y001”) is generated from the plurality of conversation contents. One summary sentence or a plurality of summary sentences may be generated for one section.

The summary generation processing unit 114 registers the summary ID in the agenda information D4 (see FIG. 6). Note that, in a case of generating a plurality of summary sentences for one agenda, the summary generation processing unit 114 registers a plurality of summary IDs corresponding to the summary sentences in the agenda information D4 in association with the agenda (agenda ID).

The voice synthesis processing unit 115 synthesizes the voices acquired by the acquisition processing unit 112. The voice synthesis processing unit 115 outputs a voice acquired by synthesis to the meeting terminal 3 (for example, the user terminal 3A) in the meeting room R1. The meeting application of the meeting server 4 transmits, to the meeting terminal 3 in the meeting room R2, the voice received by the meeting terminal 3 in the meeting room R1.

The display processing unit 116 causes various pieces of information corresponding to the meeting application to be displayed on the display screen. To be specific, the display processing unit 116 causes the text information to be converted by the voice recognition processing unit 113 and the summary sentences corresponding to the agenda to be generated by the summary generation processing unit 114 to be displayed side by side on the meeting screen P2. For example, as illustrated in FIG. 8, in the user terminal 3, the display processing unit 116 causes the text information corresponding to the conversation in progress to be displayed in a conversation display area P22 of the meeting screen P2, and causes the summary sentences generated for each predetermined section to be displayed in a summary display area P21 of the meeting screen P2. Note that, in the conversation display area P22, the display processing unit 116 sequentially displays additional text information in real time while scrolling the screen.

The display processing unit 116 causes identification information (user names, user icons, or the like) of the users of the uttered voices corresponding to the text information and the time information (utterance time) to be displayed in the conversation display area P22 in association with the text information (utterance content).

The display processing unit 116 causes identification information that can identify the section (for example, summary creation time T1) to be displayed in the summary display area P21 in association with the summary sentence. For example, in a case where the summary generation processing unit 114 generates summary sentences every five minutes, the display processing unit 116 causes the time to be displayed at time intervals of five minutes in the summary display area P21 (see FIG. 8).

Note that, in the summary display area P21, each of a plurality of itemized sentences included in one section (for example, a section from 10:06 to 10:11) is a summary sentence. As another embodiment, the summary generation processing unit 114 may generate each of the itemized sentences as a main point and compiles a plurality of main points into one summary sentence.

The display processing unit 116 causes a plurality of agendas to be selectively displayed in the summary display area P21 and causes the agenda selected by the users to be identifiably displayed. In a case where no agenda is selected in the summary display area P21, the display processing unit 116 causes summary sentences corresponding to the agenda for the conversations currently in progress to be displayed. As a result, the meeting screen P2 displays, side by side, the text information of the conversation related to the agenda for the conversations currently in progress and the summary sentences related to the agenda. The user can collectively check, on one meeting screen P2, the content and summary for the conversations currently in progress.

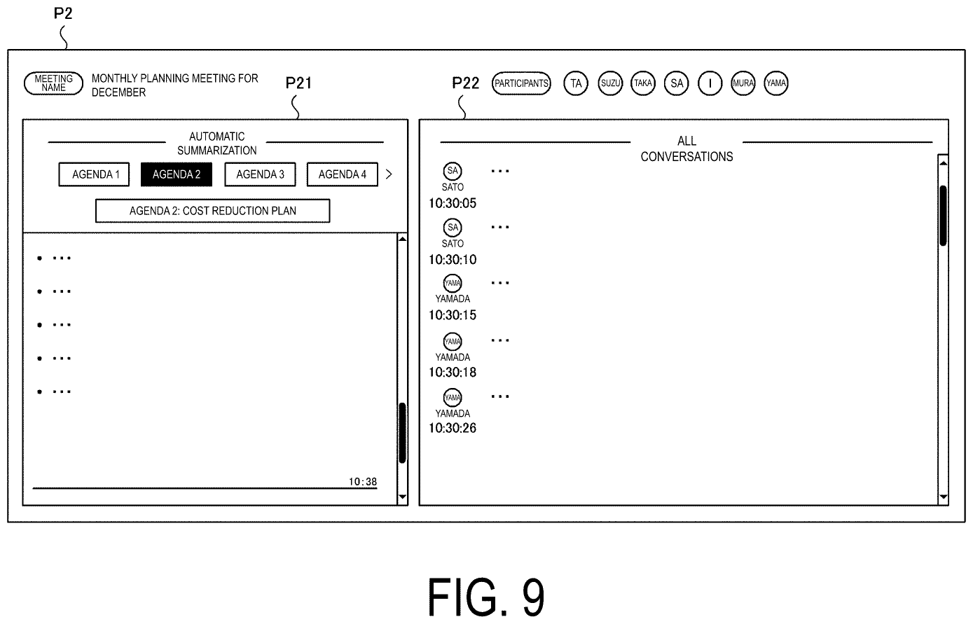

Here, when the organizer (user A) of the meeting changes the agenda from an agenda 1 (“next generation office”) to an agenda 2 (“cost reduction plan”) on the setting screen P1 (see FIG. 7A), the display processing unit 116 causes the text information related to the agenda 2 for the conversations currently in progress to be displayed in the conversation display area P22 and also causes the summary sentences corresponding to the agenda 2 to be in the summary display area P21, as illustrated in FIG. 9.

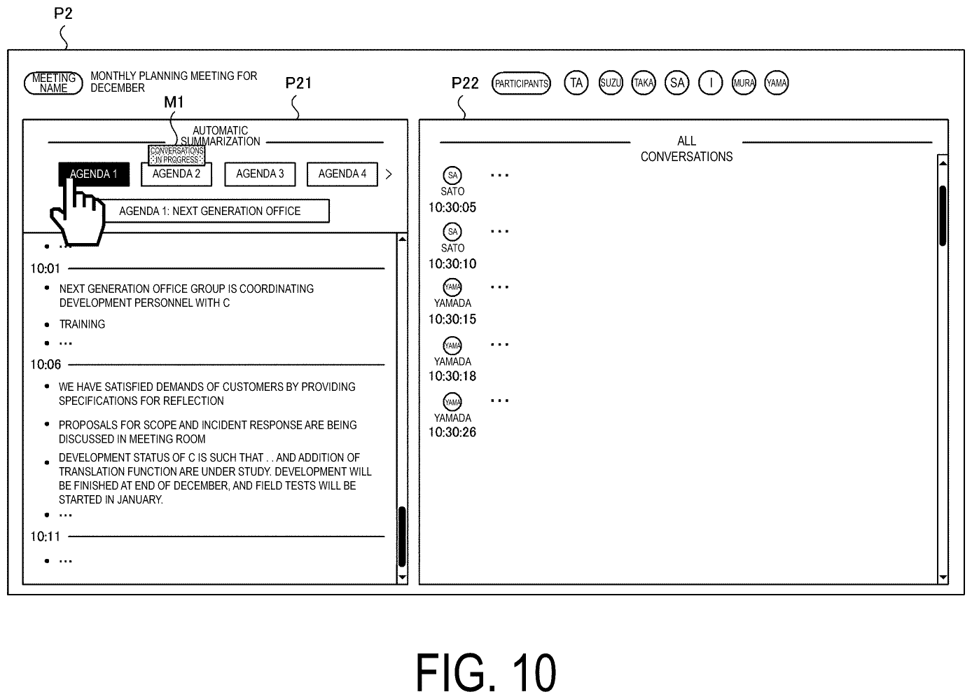

Furthermore, for example, in a case where the agenda for the conversations currently in progress is the “Agenda 2” (see FIG. 9), and the users (for example, the users B to D) select the “Agenda 1” in the summary display area P21, the display processing unit 116 causes summary sentences corresponding to the agenda 1 to be displayed in the summary display area P21 as illustrated in FIG. 10. As a result, the meeting screen P2 displays the text information related to the agenda 2 for the conversations currently in progress and the summary sentences related to the agenda 1 selected by the users. In this case, the display processing unit 116 causes an identification mark P21 that can identify the agenda 2 for the conversations currently in progress to be displayed in the summary display area M1 in association with the agenda 2 to allow the user to recognize the agenda 2 for the conversations currently in progress. As another embodiment, the display processing unit 116 may cause an icon of the agenda 2 for the conversations currently in progress and an icon of the agenda 1 selected by the users to be displayed in the summary display area P21 in different display modes.

As described above, in a case where the user desires to check the contents of the previous “Agenda 1” after the agenda of the meeting is switched from the “Agenda 1” (see FIG. 8) to the “Agenda 2” (see FIG. 9), the user can check the summary sentences for the agenda 1 by selecting the “Agenda 1” in the summary display area P21 (see FIG. 10) while conversations are in progress for the agenda 2. On one meeting screen P2, the user can collectively check the summary sentences for the agenda in the past and the conversation content for the conversations currently in progress.

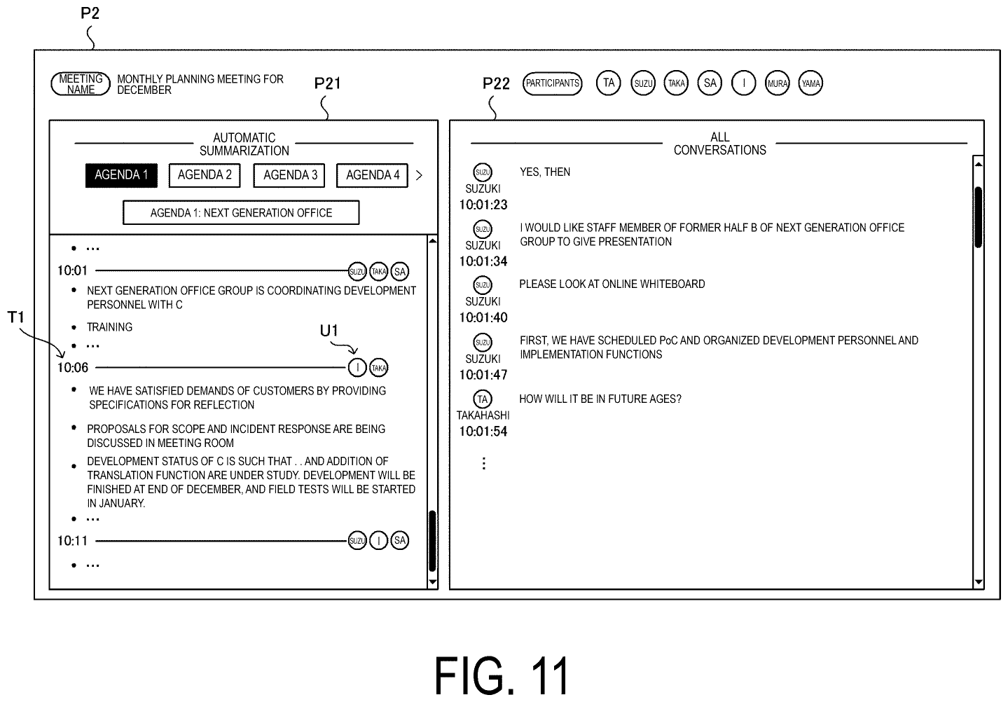

The display processing unit 116 may cause user identification information that can identify the users who have uttered within a predetermined section to be displayed in association with the summary sentence corresponding to the predetermined section. For example, as illustrated in FIG. 11, the display processing unit 116 causes a user icon Ul that can identify the users (“Suzuki”, “Takahashi”, or “Sato”) who have uttered in the section of 10:01 to 10:06 to be displayed in association with the summary sentence corresponding to the section. Accordingly, the user can recognize, on the meeting screen P2, the user who has uttered the content (text information) corresponding to the source of the summary sentence.

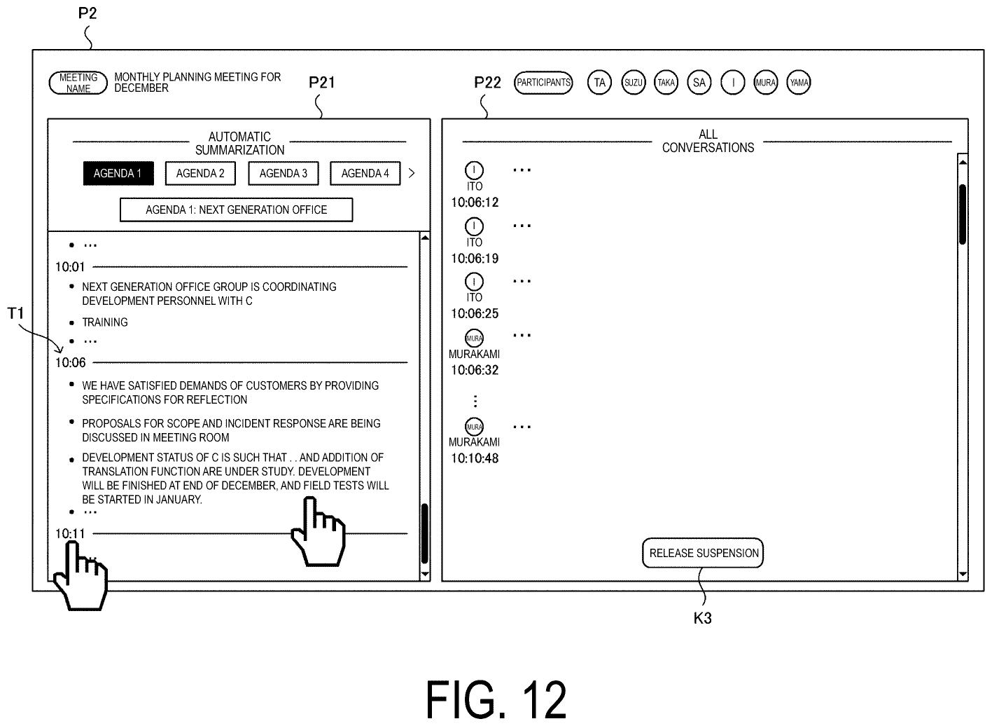

Here, in accordance with user operations on the summary display area P21 and the conversation display area P22 of the meeting screen P2, the display processing unit 116 may execute processing of changing the display content of each of the display areas. For example, as illustrated in FIG. 12, in a case where the user depresses “10:11” in the summary display area P21, which is the creation time of the summary sentence in the section of 10:06 to 10:11, or the user depresses the summary sentence for the section, the display processing unit 116 causes the text information corresponding to the source of the summary sentence to be preferentially displayed in the conversation display area P22. In this case, the display processing unit 116 suspends the processing of displaying the text information of the uttered voice acquired in real time, and causes the text information corresponding to the source of the summary sentence selected by the user to be fixedly displayed. As a result, on the meeting screen P2 displaying the summary sentences, the user can select a summary sentence of interest during conversations, and check the utterance content corresponding to the source of the summary sentence.

The display processing unit 116 may cause a release button K3 for releasing the above-described suspended state to be displayed on the meeting screen P2. When the user depresses the release button K3, the display processing unit 116 resumes, in the conversation display area P22, the processing of displaying the text information of the uttered voice in the current conversations in progress acquired in real time.

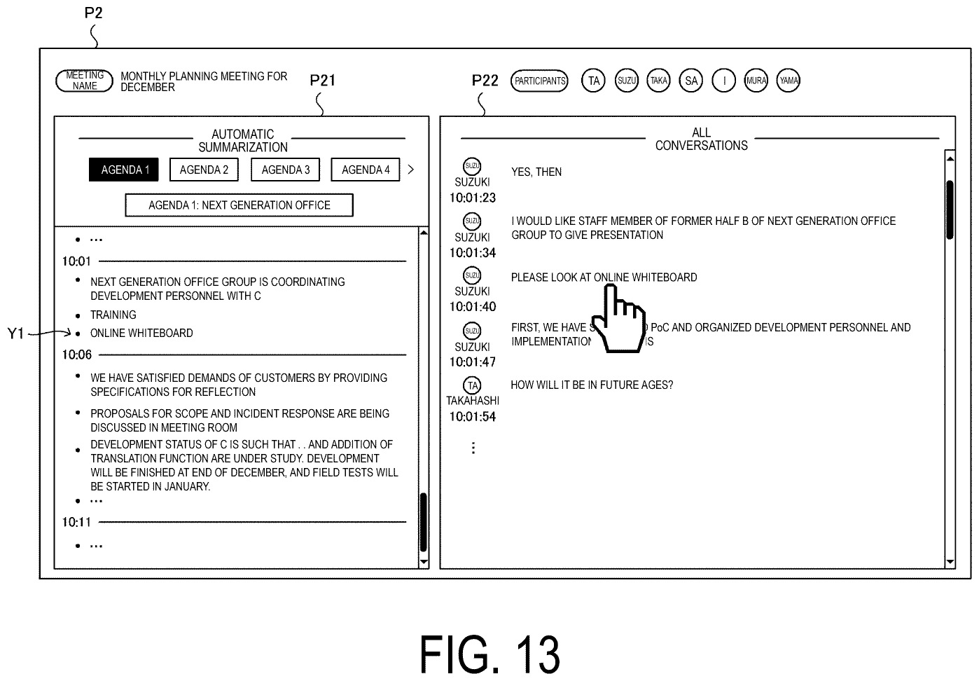

As another embodiment, for example, as illustrated in FIG. 13, in a case where the user depresses text information (conversation content) in the conversation display area P22, the display processing unit 116 may cause the text information to be additionally displayed in the summary display area P21. For example, in a case of determining that important text information is included in a plurality of pieces of text information displayed in the conversation display area P22, the user selects that text information. As a result, the display processing unit 116 causes the selected text information as a summary sentence Y1 to be additionally displayed in the summary display area P21. As another embodiment, the summary generation processing unit 114 may add the text information selected by the user to regenerate a summary sentence. In this case, the summary generation processing unit 114 may add a weight to the text information selected by the user to regenerate a summary sentence. As a result, the user can modify the summary sentence as intended. The operation of selecting the text information may be, for example, an operation in which the user moves the text information from the conversation display area P22 to the summary display area P21 (drag-and-drop operation).

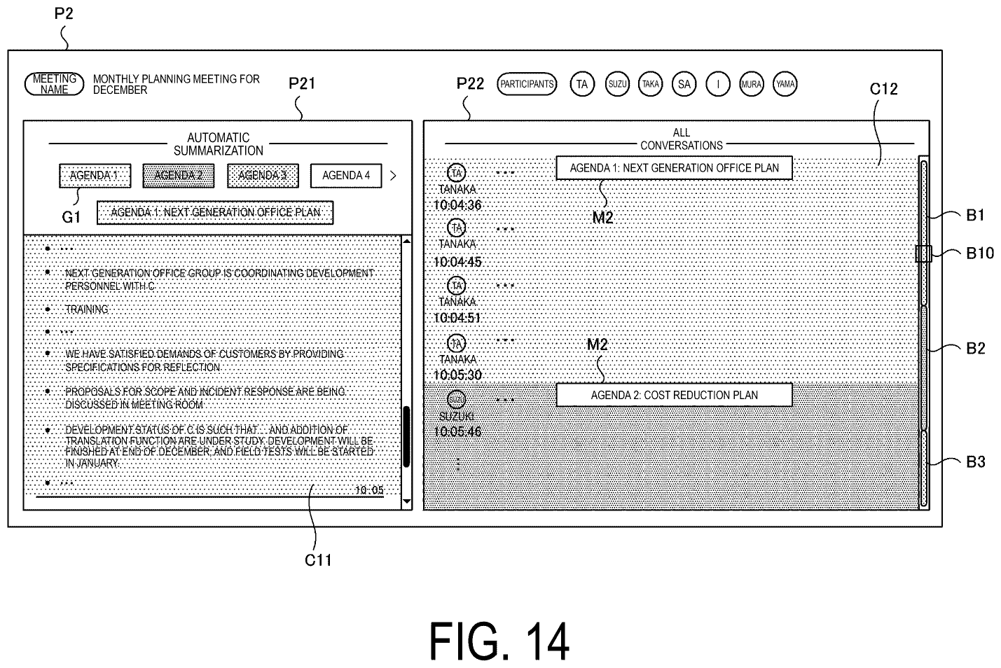

The display processing unit 116 may vary the display mode of the summary sentences and the text information on a per-agenda basis. For example, as illustrated in FIG. 14, the display processing unit 116 causes a background image of an agenda icon G1 and a background image C11 of the summary sentences to be displayed in the summary display area P21 in a mode corresponding to the agenda, and causes a background image C12 of the text information to be displayed in the conversation display area P22 in a mode corresponding to the agenda. For example, as illustrated in FIG. 14, the display processing unit 116 causes the agenda icon G1 of the agenda 1, the summary sentences for the agenda 1, and the text information corresponding to sources of the summary sentences for the agenda 1 to be displayed in the same display mode (for example, the same background image).

In the conversation display area P22, the display processing unit 116 causes scroll bars B1 to B3 corresponding to the respective agendas 1 to 3 to be displayed in modes corresponding to the agendas, and causes each scroll bar to be displayed at a length according to the ratio of the conversation times related to the agenda. In the conversation display area P22, the display processing unit 116 causes a position mark B10 indicating the position of the text information being displayed to be displayed on the scroll bar. Accordingly, the user can recognize the length of the conversation corresponding to each agenda, the position of the conversation content currently being displayed, and the like.

As illustrated in FIG. 14, the display processing unit 116 may cause an identification mark M2 that can identify the agenda to be displayed in the conversation display area P22.

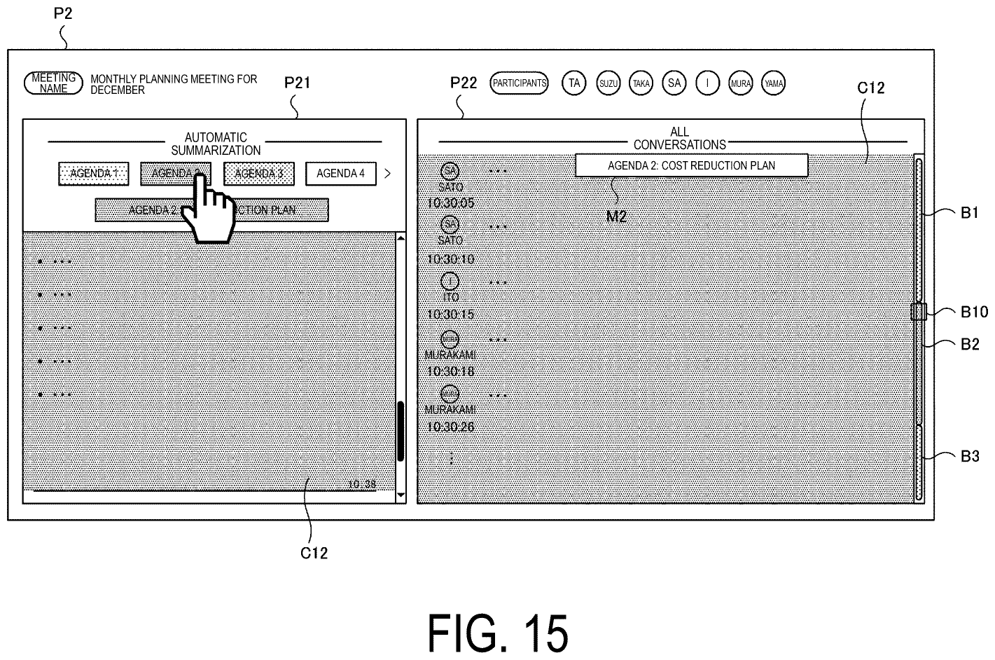

In the configuration illustrated in FIG. 14, for example, in a case where the user selects the agenda icon G1 (“Agenda 2”), the display processing unit 116 may cause the summary sentences for the agenda 2 to be displayed in the summary display area P21 and causes the text information corresponding to the conversation for the agenda 2 to be displayed at a default position in the conversation display area P22, as illustrated in FIG. 15. Here, the position mark B10 is displayed at the top of the scroll bar B2 corresponding to the agenda 2.

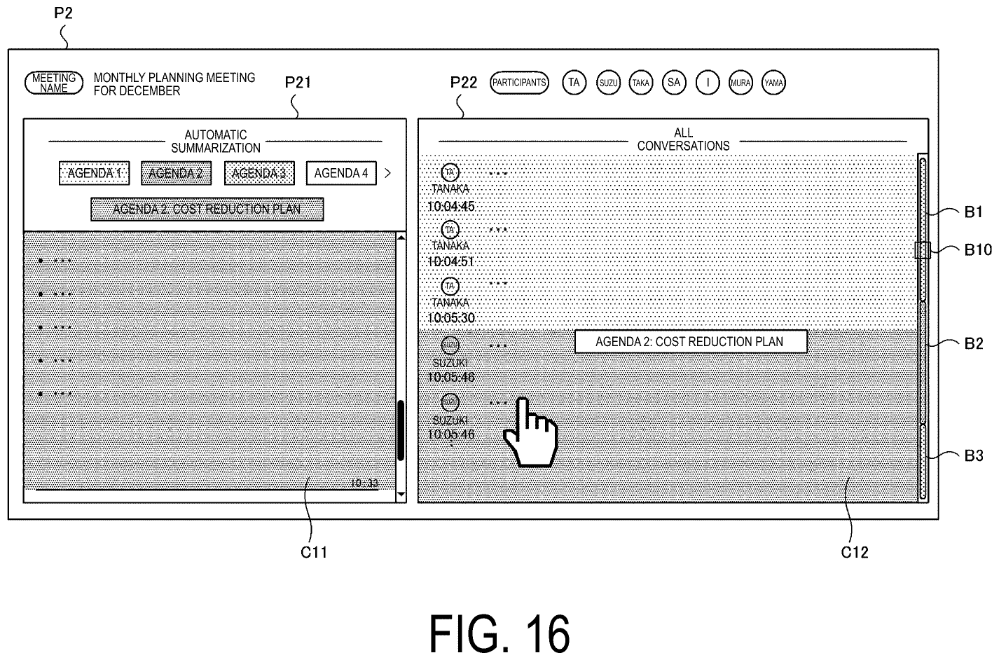

In the configuration illustrated in FIG. 14, for example, in a case where the user selects the conversation content (text information) for the agenda 2 in the conversation display area P22, the display processing unit 116 may cause the summary sentence corresponding to the selected conversation content for the agenda 2 to be displayed at the default position in the summary display area P21 as shown in FIG. 16. Note that the display processing unit 116 can extract a summary sentence (summary ID) corresponding to the conversation content (conversation ID) with reference to the summary information D3 illustrated in FIG. 5.

As described above, the controller 11 converts voices uttered by users into text information, generates summary sentences based on the text information, and causes the text information and the summary sentences to be displayed side by side on the meeting screen P2. The controller 11 sets agendas of the conversation, generates the summary sentence for each agenda, and causes the text information and the summary sentences corresponding to the agenda to be displayed side by side on the meeting screen P2.

### Wraparound Voice Control

In a case where a plurality of audio devices 2 are used in the same space, an uttered voice of one user may be input to a plurality of audio devices 2 to generate a plurality of pieces of text information for the same uttered voice, the same uttered voice may be subjected to synthesis processing, and the like. The problem with this case is that the accuracy of voice processing decreases. For example, in a case where the user B utters in the meeting room R1 (see FIG. 1), the uttered voice of the user B may be input not only to the microphone of the audio device 2B of the user B but also to the microphones of the audio devices 2A, 2C, and 2D of the other users A, C, and D (wraparound input). The problem with this case is that a plurality of pieces of text information may be generated that correspond to voices acquired from the respective audio devices 2 and that have the same content or a plurality of voices having the same content are subjected to synthesis processing. Thus, the meeting assistance device 1 of the present disclosure may include a configuration for solving the problem.

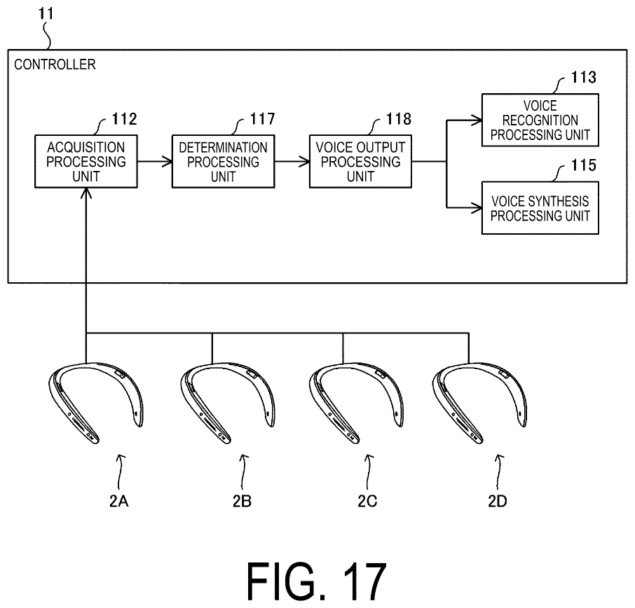

Specifically, as illustrated in FIG. 17, in addition to the processing units illustrated in FIG. 2, the controller 11 further includes a determination processing unit 117 that determines whether a plurality of voices received substantially simultaneously from the plurality of audio devices 2 are similar to one another, and a voice output processing unit 118 that outputs a voice based on a determination result from the determination processing unit 117.

The determination processing unit 117 determines the degree of similarity between a plurality of voices that are substantially simultaneously input to the microphones of the plurality of audio devices 2 arranged in the same space. For example, the determination processing unit 117 compares the waveforms of the plurality of voices acquired by the acquisition processing unit 112 to determine the degree of similarity. The determination processing unit 117 determines whether the degree of similarity between the plurality of voices is equal to or greater than a threshold value. The threshold value is set to, for example, a reference value that can be used to determine whether voices heard by a person with the person's own ears are the same.

The voice output processing unit 118 outputs the above-described voice to the voice processing units (the voice recognition processing unit 113 and the voice synthesis processing unit 115) based on the determination result from the determination processing unit 117. Specifically, in a case where the degree of similarity between the plurality of voices is equal to or greater than a threshold value, the voice output processing unit 118 outputs a specific voice (first voice) among the plurality of voices to the voice recognition processing unit 113 and the voice synthesis processing unit 115. In other words, when the plurality of voices acquired by the acquisition processing unit 112 are substantially the same, the voice output processing unit 118 outputs one of the plurality of voices to the voice recognition processing unit 113 and the voice synthesis processing unit 115.

In a case where the degree of similarity between the plurality of voices is equal to or greater than the threshold value, the voice output processing unit 118 outputs, to the voice recognition processing unit 113 and the voice synthesis processing unit 115, a voice (first voice) having the maximum sound pressure among the plurality of voices. For example, in a case where the user B utters, the voice input to the microphone of the audio device 2B of the user B has the maximum sound pressure, and the voices input to the microphones of the audio devices 2B, 2C, and 2D located away from the audio device 2A have sound pressures lower than that of the voice input to the microphone of the audio device 2B. Thus, the voice output processing unit 118 determines that the voice having the maximum sound pressure among the plurality of similar voices is a regular voice, and outputs only the voice having the maximum sound pressure to the voice recognition processing unit 113 and the voice synthesis processing unit 115 while excluding the other voices. As a result, the voice recognition processing unit 113 can execute the voice recognition processing based on the appropriate voice, and thus one appropriate summary sentence can be generated by the subsequent processing by the summary generation processing unit 114. The voice synthesis processing unit 115 can execute the synthesis processing based on the appropriate voice, and thus the appropriate voice can be reproduced in the meeting room R2.

As another embodiment, in a case where the degree of similarity among the plurality of voices is equal to or greater than the threshold value, the voice output processing unit 118 may output, to the voice recognition processing unit 113 and the voice synthesis processing unit 115, a voice (first voice) having the shortest delay time among the plurality of voices. For example, in a case where the user B utters, the voice input to the microphone of each of the audio devices 2B, 2B, and 2D located away from the audio device 2A has a longer delay time than that of the voice input to the microphone of the audio device 2B of the user B. Accordingly, the voice input to the microphone of the audio device 2B of the user B is first input to the acquisition processing unit 112, and after a predetermined time has elapsed, the voices input to the microphones of the audio devices 2A, 2C, and 2D are sequentially input according to the distance. Thus, the voice output processing unit 118 determines that the voice with the shortest delay time (the voice that reaches the meeting assistance device 1 earliest) among the plurality of similar voices is a regular voice, and outputs only the voice with the shortest delay time to the voice recognition processing unit 113 and the voice synthesis processing unit 115 while excluding the other voices.

Note that the controller 11 may determine the voice to be output based on both the sound pressure and the delay time. For example, the controller 11 extracts top a plurality of voices in descending order of sound pressure from among the plurality of similar voices, and determines, as the voice to be output, a voice having the shortest delay time from among the plurality of extracted voices.

In a case where the degree of similarity among the plurality of voices is less than the threshold value, the voice output processing unit 118 outputs the plurality of voices to the voice recognition processing unit 113 and the voice synthesis processing unit 115. For example, in a case where a plurality of users utter substantially at the same time, voices having different waveforms are input to the acquisition processing unit 112. In this case, the determination processing unit 117 determines that the plurality of voices are not similar to one other, and the voice output processing unit 118 outputs each of the plurality of voices to the voice recognition processing unit 113 and the voice synthesis processing unit 115. In this case, the voice recognition processing unit 113 executes the voice recognition processing on each voice in order. The voice synthesis processing unit 115 synthesizes the voices into one voice and outputs the resultant voice to the meeting terminal 3.

As another embodiment, in a case where the degree of similarity among the plurality of voices is less than the threshold value, the voice output processing unit 118 may output a predetermined number of voices from among the plurality of voices to the voice recognition processing unit 113 and output the plurality of voices to the voice synthesis processing unit 115. For example, with ten audio devices 2 connected to the meeting assistance device 1, when the voice recognition processing and the summary sentence generation processing are performed on the voices substantially simultaneously received from the respective ten audio devices 2, then much processing time may be required and display of the text information and the summary sentences may be delayed. Thus, the voice output processing unit 118 selects top three voices in descending order of sound pressure from among the ten voices acquired from the respective ten audio devices 2, and outputs the selected voices to the voice recognition processing unit 113. Note that the ten voices are input to the voice synthesis processing unit 115. As a result, the voice recognition processing unit 113 executes the voice recognition processing based on the specific three voices, and the voice synthesis processing unit 115 executes processing of synthesizing the ten voices into one voice.

The above-described configuration can prevent the problem that a plurality of summary sentences are generated that correspond to the respective voices acquired from the corresponding audio devices 2 or a plurality of voices having the same contents are subjected to the synthesis processing.

### Conference Assistance Processing

FIG. 18 illustrates an example of a procedure of meeting assistance processing executed by the controller 11 of the meeting assistance device 1.

Note that the present disclosure can be regarded as a meeting assistance method (information processing method and voice processing method of the present disclosure) of executing one or more steps included in the meeting assistance processing. One or more steps included in the meeting assistance processing described herein may be omitted as appropriate. Each of the steps in the meeting assistance processing may be executed in a different order to the extent that similar effects are produced. Furthermore, here, a case in which the controller 11 executes each of the steps in the meeting assistance processing will be described as an example, but in another embodiment, one or more processors may execute each of the steps in the meeting assistance processing in a distributed manner.

Here, as illustrated in FIG. 1, a case where a meeting is held using a plurality of audio devices 2 arranged in the meeting room R1 will be described as an example. Agendas are assumed to be registered in advance before the meeting is started. Note that the user can also register an agenda during the meeting after the start of the meeting.

First, in step S1, the controller 11 determines whether an operation of starting the meeting has been received. For example, the user A who is the organizer of the meeting activates the meeting application on the meeting terminal 3 (the user terminal 3A) and depresses a start button K1 on the setting screen 7A (see FIG. 7A). In a case of receiving an operation of depressing the start button K1, the controller 11 determines that the meeting start operation has been received. The controller 11 determines that the meeting start operation has been received (S1: Yes), and transitions the processing to step S2. The controller 11 waits until the meeting start operation is received (S1: No).

Next, in step S2, the controller 11 starts processing of acquiring, from the audio device 2, a voice uttered by a user. For example, when the meeting is started and a voice uttered by the user B is input to the microphone of the audio device 2B, the controller 11 acquires the voice from the audio device 2B. In a case where the voice of the user B is also input to the microphone of the audio device 2 of another user, the controller 11 also acquires the voice from this audio device 2.

Next, in step S3, the controller 11 determines whether an operation of setting an agenda of the meeting. For example, when the user A selects an agenda of the meeting on the setting screen P1, the controller 11 receives the selection operation. Upon receiving the selection operation (S3: Yes), the controller 11 transitions the processing to step S4. The controller 11 waits until the selection operation is received from the user (S3: No).

In step S4, the controller 11 sets the agenda selected by the users. Upon setting the agenda, the controller 11 registers information regarding the agenda (agenda ID, agenda name, and the like) in the agenda information D4 (see FIG. 6).

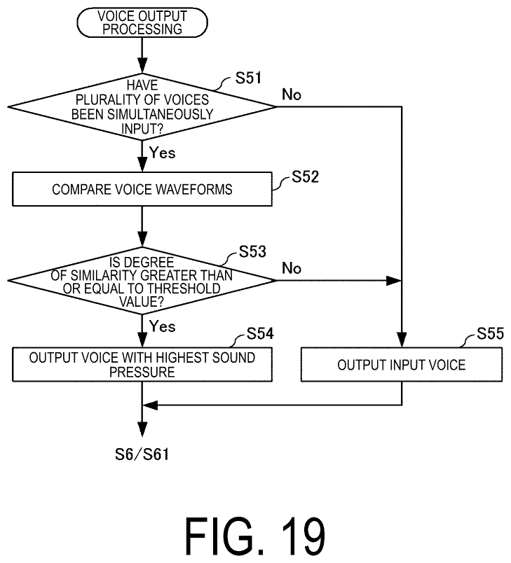

Next, in step S5, the controller 11 executes voice output processing. The controller 11 outputs a voice acquired from one audio device 2 or a plurality of voices acquired substantially simultaneously from a plurality of audio devices 2 to the voice recognition processing unit and the voice synthesis processing unit according to a predetermined condition. FIG. 19 illustrates a specific example of the voice output processing.

In step S51 of FIG. 19, the controller 11 determines whether a plurality of voices have each been substantially simultaneously received from a respective one of the plurality of audio devices 2. In a case of determining that a plurality of voices have been substantially simultaneously received (S51: Yes), the controller 11 transitions the processing to step S52. On the other hand, in a case of determining that a plurality of voices have not been substantially simultaneously received (S51: No), the controller 11 transitions the processing to step S55.

In step S52, the controller 11 compares the waveforms of the plurality of voices with one another. Next, in step S53, the controller 11 determines whether the degree of similarity among the plurality of voices is equal to or greater than a threshold value. Specifically, the controller 11 compares the waveforms of the voices with one another to calculate the degree of similarity among the voices, and determines whether the calculated degree of similarity is equal to or greater than the threshold value. Upon determining that the degree of similarity is equal to or greater than the threshold value (S53: Yes), the controller 11 transitions the processing to step S54. On the other hand, upon determining that the degree of similarity is less than the threshold value (S53: No), the controller 11 transitions the processing to step S55.

In step S54, the controller 11 outputs, to the voice recognition processing unit and the voice synthesis processing unit, the voice having the highest sound pressure from among the plurality of similar voices. As another embodiment, the controller 11 may output, to the voice recognition processing unit and the voice synthesis processing unit, the voice having the shortest delay time (the earliest arrival time) from among the plurality of similar voices.

On the other hand, in step S55, the controller 11 outputs the input one or more voices to the voice recognition processing unit and the voice synthesis processing unit. For example, in a case where the plurality of voices have not been substantially simultaneously received (S51: No), the controller 11 outputs each of the voices to the voice recognition processing unit and the voice synthesis processing unit in the order of input. For example, in a case where the plurality of voices are not similar (S53: No), the controller 11 outputs each of the voices to the voice recognition processing unit and the voice synthesis processing unit.

After the sound output processing (S5), the controller 11 transitions the processing to steps S6 and S61 (see FIG. 18).

In step S6, the controller 11 executes the voice recognition processing. To be specific, the controller 11 uses a predetermined voice recognition engine (learned model) to acquire the voice output in step S5 and to convert the voice into text information. The controller 11 registers the text information (utterance content) in the utterance information D2 in association with the time information (utterance time), the utterer, and the agenda (agenda ID) (see FIG. 4).

Next, in step S7, the controller 11 executes processing of generating summary sentences. Specifically, the controller 11 generates summary sentences from the text information using a predetermined summary generation engine (learned model). The controller 11 generates summary sentences for each predetermined section. Specifically, the controller 11 generates summary sentences per predetermined time (for example, every 5 minutes) or for every predetermined number of characters (for example, for every 1500 characters) of the text information.

The controller 11 registers each generated summary sentence (summary content) in the summary information D3 in association with the section (section ID), the summary ID, the conversation (conversation ID) corresponding to the text information, and the agenda ID (see FIG. 5). The controller 11 registers the summary ID in the agenda information D4 (see FIG. 6).

Next, in step S8, the controller 11 causes the text information and the summary sentences to be displayed on the display screen. To be specific, in the meeting screen P2 (see FIG. 8), the controller 11 causes the text information for the conversations in progress to be displayed in the conversation display area P22, while causing the summary sentences generated for each predetermined section to be displayed in the summary display area P21. In the conversation display area P22, the controller 11 sequentially displays additional text information in real time while scrolling the screen. In the conversation display area P22, the controller 11 causes the identification information (user names, user icons) of the users of the uttered voices corresponding to the text information and the time information (utterance time) to be displayed in association with the text information.

In the summary display area P21, the controller 11 causes the identification information (summary creation times) that can identify the sections and the user icon Ul that can identify the users who have uttered in the section to be displayed in association with the summary sentences corresponding to the section (see FIG. 11).

Next, in step S9, on the meeting screen P2, the controller 11 determines whether a user operation has been received. Upon determining, on the meeting screen P2, that a user operation has been received (S9: Yes), the controller 11 transitions the processing to step S10. On the other hand, upon determining, on the meeting screen P2, that no user operation has been received (S9: No), the controller 11 transitions the processing to step S11. For example, on the meeting screen P2, the user can perform an operation of selecting an agenda, an operation of selecting a summary sentence, an operation of selecting text information (conversation content), and the like.

In step S10, the controller 11 executes display change processing according to the user operation. For example, in a case where the agenda for the conversations currently in progress is the “Agenda 2” (see FIG. 9), and the user selects the “Agenda 1” in the summary display area P21, then the controller 11 causes the summary sentences corresponding to agenda 1 to be displayed in the summary display area P21 as illustrated in FIG. 10. In this case, in the summary display area P21, the controller 11 causes an identification mark M1 that can identify the “Agenda 2” for the conversations currently in progress to be displayed in the vicinity of the “Agenda 2”.

For example, as illustrated in FIG. 12, in a case where the user depresses “10:11”, which is the creation time for the summary sentences for a specific section (section of 10:06 to 10:11) in the summary display area P21, or the user depresses any of the summary sentences in the section, the controller 11 causes the conversation content (text information) corresponding to the source of the summary sentence to be displayed in the conversation display area P22. Note that, upon depressing the release button K3, the controller 11 resumes the processing of displaying real-time conversation contents in the conversation display area P22.

For example, as illustrated in FIG. 13, in a case where the user depresses any of the conversation contents (text information) in the conversation display area P22, the controller 11 causes the text information (summary sentence Y1) to be additionally displayed in the summary display area P21.

After step S10, the controller 11 transitions the processing to step S11.

On the other hand, in step S61, the controller 11 executes the voice synthesis processing. Specifically, in a case where a plurality of similar voices are substantially simultaneously input, the controller 11 executes the synthesis processing on the voice having the highest sound pressure. In a case where a plurality of dissimilar voices are substantially simultaneously input, the controller 11 executes processing of synthesizing the plurality of voices into one voice.

Next, in step S62, the controller 11 outputs, to the meeting terminal 3 (for example, the user terminal 3A), the voice obtained by synthesis. The meeting application of the meeting server 4 transmits, to the meeting terminal 3 in the meeting room R2, the voice received by the meeting terminal 3 in the meeting room R1. After step S62, the controller 11 transitions the processing to step S11.

In step S11, the controller 11 determines whether an operation of ending the meeting has been received. For example, the user A ends the meeting application in a case of ending the meeting. In a case of having received the operation of ending the meeting application, the controller 11 determines that the meeting end operation has been received. The controller 11 determines that the meeting end operation has been received (S11: Yes), and ends the meeting assistance processing. On the other hand, in a case of not having received the meeting end operation (S11: No), the controller 11 returns the processing to step S1.

Back in step S1, for example, when the user A performs an operation of changing the agenda, the controller 11 sets a new agenda (S4) and starts conversations for the agenda. For example, the user depresses an end button K2 on the setting screen P11 (see FIG. 7B) and selects another agenda on the setting screen P1 (see FIG. 7A). When the selected agenda is set (S4), the controller 11 executes the above-described processing (S5 to S10) on the voices of the utterance contents related to the agenda. The controller 11 repeatedly executes the above-described processing in accordance with the agenda until the meeting ends.

Here, when the user sets, for example, the “Agenda 1” and changes to the “Agenda 2” after conversations for Agenda 1 are made, summary sentences for each of the Agenda 1 and Agenda 2 are generated. In a case where the user returns to the “Agenda 1” and conversations are made, summary sentences for the previous conversations related to the Agenda 1 and summary sentences for the subsequent conversation related to Agenda 1 are generated. As another embodiment, the controller 11 may re-generate summary sentences in which the summary sentences for the previous conversations and the summary sentences for the subsequent conversations are compiled for the “Agenda 1”. As described above, even in a case where the agenda is changed to a new one or returned to the original agenda, appropriate summary sentences can be generated for each subject. On the meeting screen P2, the user can check the summary sentences and the conversation contents for the previous conversations and the summary sentences and the conversation contents for the subsequent conversations for the same agenda.

As another embodiment, the controller 11 may generate minutes of the meeting in a case where the meeting ends. For example, when a meeting is held for a plurality of agendas, the controller 11 generates, for each agenda, minutes including compiled summary sentences. The controller 11 may generate a gist, a conclusion, an action item, and the like for one agenda based on the plurality of summary sentences of the agenda, and compiles the gist, the conclusion, the action item, and the like into minutes. The controller 11 may store the minutes in the storage 12 or may upload the minutes to a shared folder of a data server (not illustrated). Each user may be able to access the shared folder and view the minutes on the user terminal 3.

As described above, the meeting assistance system 100 according to the present disclosure acquires voices uttered by users, converts the voices into text information, generates summary sentences based on the text information, and displays the text information and the summary sentences side by side on a display screen (Conference screen P2). As a result, the utterance contents corresponding to the sources of the summary sentences can be checked together with the summary results, thus enabling improvement of the convenience of the function of displaying the summary based on the utterance content.

As another embodiment, the meeting assistance system 100 sets agendas of conversations, acquires voices uttered by users, converts the voices into text information, generates summary sentences for each agenda based on the text information, and displays, side by side on a display screen, the text information and the summary sentences corresponding to the agenda (meeting screen P2). This allows the summary sentences for each agenda to be recognized and also allows the utterance contents corresponding to the sources of the summary sentences to be checked together with the summary results, thus enabling the convenience to be further improved.

In each of the above-described embodiments, the meeting assistance system 100 may further acquire a voice uttered by a user and input to a microphone of each of a plurality of audio devices 2 arranged in the same space, determine a degree of similarity between a plurality of voices acquired from each of the plurality of audio devices, and output a specific first voice among the plurality of voices to the voice processing unit when the degree of similarity between the plurality of voices is equal to or greater than a threshold. As a result, it is possible to prevent a problem that accuracy of voice processing is lowered, such as generation of a plurality of summary sentences corresponding to respective voices input substantially simultaneously from the audio devices 2 or synthesis processing of a plurality of voices having the same content.

In the example described above in the embodiment, the meeting room R1 and the meeting room R2 are connected through the network for the online meeting. However, the meeting assistance system 100 of the present disclosure may be configured with only one meeting room R1. In this case, for example, in the meeting room R1, the meeting assistance device 1 executes transcription processing for causing the display device 5 to display text information obtained by converting the voice input to the microphone of the audio device 2. One audio device 2 (for example, a stationary microphone speaker device) may be installed in the meeting room R1, and the meeting assistance device 1 may convert voices of one or more users input to the microphone of the audio device 2 into text information. That is, in a case where the meeting assistance system 100 includes a transcription function, a plurality of audio devices 2 may be arranged for each user, or one audio device 2 may be arranged for a meeting room or a plurality of users.

In another embodiment, the voice recognition processing may include a translation function of converting a voice in a first language (e.g., Japanese) into text in a second language (e.g., English). For example, the controller 11 may translate each of the text information and the summary sentence and display the resultant text information and summary sentence, or may display the text information in the language of the conversation in the conversation display area P22 without translating the text information, and translate only the summary sentence and display the resultant summary sentence in the summary display area P21. By translating only the summary sentence, the time and cost required for translation can be reduced. The controller 11 may display, on the meeting screen P2, a translation button enabling the translation function to be switched on/off.

### Supplementary Notes of Disclosure 1

Hereinafter, an outline of the disclosure extracted from the above-described embodiments will be described as supplementary notes. Note that configurations and processing functions described in the following supplementary notes can be selected and combined as desired.

### Supplementary Note 1

An information processing system including:
an acquisition processing circuit that acquire voices uttered by users;
a conversion processing circuit that converts the voices acquired by the acquisition processing circuit into text information; and
a generation processing circuit that generates, based on the text information to be converted by the conversion processing circuit, summary sentences summarizing utterance contents of the users; and
a display processing circuit that causes the text information to be converted by the conversion processing circuit and the summary sentences generated by the generation processing circuit to be displayed side by side on a display screen.

### Supplementary Note 2

The information processing system according to Supplementary Note 1, wherein the display processing circuit causes time information corresponding to utterance time of each of the voices to be displayed in association with the text information.

### Supplementary Note 3

The information processing system according to Supplementary Note 1 or 2, wherein
the generation processing circuit generates the summary sentences per predetermined section, and
the display processing circuit displays the summary sentences for each predetermined section.

### Supplementary Note 4

The information processing system according to Supplementary Note 3, wherein
the generation processing circuit generates the summary sentences per predetermined time or for every predetermined number of characters of the text information.

### Supplementary Note 5

The information processing system according to Supplementary Note 3 or 4, wherein the display processing circuit causes the predetermined sections to be identifiably displayed.

### Supplementary Note 6

The information processing system according to any one of Supplementary Notes 3 to 5, wherein
the display processing circuit causes user identification information that can identify the users who have uttered within the predetermined section to be displayed in association with the summary sentences corresponding to the predetermined section.

### Supplementary Note 7

The information processing system according to any one of Supplementary Notes 1 to 6, wherein
the display processing circuit causes the text information corresponding to a source of the summary sentence selected by a user from among a plurality of the summary sentences displayed to be preferentially displayed.

### Supplementary Note 8

The information processing system according to any one of Supplementary Notes 1 to 7, wherein
the display processing circuit causes a translated sentence of the summary sentence to be displayed in association with the summary sentence.

### Supplementary Notes of Disclosure 2

Hereinafter, an outline of the disclosure extracted from the above-described embodiments will be described as supplementary notes. Note that configurations and processing functions described in the following supplementary notes can be selected and combined as desired.

### Supplementary Note 1

An information processing system including:
a setting processing circuit that sets agendas of conversations;
an acquisition processing circuit that acquire voices uttered by users;
a conversion processing circuit that converts the voices acquired by the acquisition processing circuit into text information;
a generation processing circuit that generates, based on the text information to be converted by the conversion processing circuit, summary sentences summarizing utterance contents of the users for each of the agendas set by the setting processing circuit; and
a display processing circuit that causes the text information to be converted by the conversion processing circuit and the summary sentences corresponding to the agenda to be generated by the generation processing circuit to be displayed side by side on a display screen.

### Supplementary Note 2

The information processing system according to Supplementary Note 1, wherein
the display processing circuit causes the text information for conversations currently in progress to be displayed in a first region of the display screen, and causes the summary sentences corresponding to the agenda selected by the users to be displayed in a second region of the display screen.

### Supplementary Note 3

The information processing system according to Supplementary Note 1 or 2, wherein
the display processing circuit
causes a plurality of the agendas set by the setting processing circuit to be selectively displayed on the display screen, and
causes the summary sentences corresponding to the agenda selected by the users from among a plurality of the agendas to be displayed.

### Supplementary Note 4

The information processing system according to Supplementary Note 3, wherein
the display processing circuit causes the text information corresponding to sources of the summary sentences corresponding to the agenda selected by the users from among the text information to be converted by the conversion processing circuit to be preferentially displayed.

### Supplementary Note 5

The information processing system according to Supplementary Note 3 or 4, wherein
the display processing circuit causes the text information corresponding to sources of the summary sentences corresponding to the agenda selected by the users from among the text information to be converted by the conversion processing unit to be displayed in a display mode different from a display mode for the text information corresponding to sources of the summary sentences corresponding to the agenda not selected by the users.

### Supplementary Note 6

The information processing system according to any one of Supplementary Notes 3 to 5, wherein
the display processing circuit causes the summary sentence generated based on a piece of the text information selected by the user from among the text information displayed on the display screen to be displayed on the display screen.

### Supplementary Note 7

The information processing system according to any one of Supplementary Notes 3 to 6, wherein
the display processing circuit causes the agenda for conversations currently in progress and the agenda selected by the users to be respectively identifiably displayed on the display screen.

### Supplementary Note 8

The information processing system according to any one of Supplementary Notes 1 to 7, wherein
the display processing circuit causes time information corresponding to utterance time of each of the voices to be displayed in association with the text information.

### Supplementary Note 9

The information processing system according to any one of Supplementary Notes 1 to 8, wherein
the generation processing circuit generates the summary sentences per predetermined time or for every predetermined number of characters of the text information, and
the display processing circuit causes the summary sentences to be displayed per predetermined time or for every predetermined number of characters.

### Supplementary Note 10

The information processing system according to any one of Supplementary Notes 1 to 9, wherein
the setting processing circuit receives, from the user on a setting screen different from the display screen, at least one of an operation of adding a new agenda, an operation of designating the agenda and starting conversations, or an operation of changing the agenda for the conversations currently in progress.

### Supplementary Note 11

The information processing system according to claim 10, wherein
the display processing circuit causes the agenda for conversations currently in progress to be identifiably displayed on the setting screen.

### Supplementary Notes of Disclosure 3

Hereinafter, an outline of the disclosure extracted from the above-described embodiments will be described as supplementary notes. Note that configurations and processing functions described in the following supplementary notes can be selected and combined as desired.

### Supplementary Note 1

A voice processing system including:
an acquisition processing circuit that acquires voices uttered by users and input to microphones of a respectively plurality of audio devices arranged in the same space;
a determination processing circuit that determines a degree of similarity among a plurality of voices each acquired from a respective one of the plurality of audio devices; and
an output processing circuit that outputs a specific first voice among the plurality of voices to a voice processing circuit in a case where the degree of similarity from among the plurality of voices is equal to or greater than a threshold value.

### Supplementary Note 2

The voice processing system according to Supplementary Note 1, wherein
the output processing circuit outputs the first voice having a highest sound pressure from among the plurality of voices to the voice processing circuit in a case where the degree of similarity among the plurality of voices is equal to or greater than the threshold value.

### Supplementary Note 3

The voice processing system according to Supplementary Note 1 or 2, wherein
the output processing circuit outputs the first voice having a shortest delay time from among the plurality of voices to the voice processing circuit in a case where the degree of similarity among the plurality of voices is equal to or greater than the threshold value.

### Supplementary Note 4

The voice processing system according to any one of Supplementary Notes 1 to 3, wherein
the output processing circuit outputs the plurality of voices to the voice processing circuit in a case where the degree of similarity among the plurality of voices is less than the threshold.

### Supplementary Note 5

The voice processing system according to any one of Supplementary Notes 1 to 4, wherein
the determination processing circuit determines the degree of similarity by comparing waveforms of the respective plurality of voices.

### Supplementary Note 6

The voice processing system according to any one of Supplementary Notes 1 to 5, wherein
the voice processing circuit executes at least one of voice conversion processing of converting the voice acquired by the acquisition processing circuit into text information or voice synthesis processing of synthesizing the voice acquired by the acquisition processing circuit.

### Supplementary Note 7

The voice processing system according to any one of Supplementary Notes 1 to 6, wherein
the voice processing circuit:
converts the first voice into text information in a case where the degree of similarity among the plurality of voices is equal to or greater than the threshold, and
converts each of the plurality of voices into text information in a case where the degree of similarity among the plurality of voices is less than the threshold.

### Supplementary Note 8

The voice processing system according to Supplementary Note 6, wherein
the output processing circuit outputs a predetermined number of voices among the plurality of voices to the voice processing circuit that executes the voice conversion processing and outputs the plurality of voices to the voice processing circuit that executes the voice synthesis processing in a case where the degree of similarity among the plurality of voices is less than the threshold value.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A voice processing system comprising one or more processors, wherein
the one or more processors are configured to:
acquire voices uttered by users and input to respective microphones of a plurality of audio devices arranged in the same space;
determine a degree of similarity among a respective plurality of voices acquired from the plurality of audio devices;
and
output a specific first voice from among the plurality of voices to a voice processing unit in a case where the degree of similarity among the plurality of voices is equal to or greater than a threshold value.

2. The voice processing system according to claim 1, wherein
the one or more processors output the first voice having a highest sound pressure from among the plurality of voices to the voice processing unit in a case where the degree of similarity among the plurality of voices is equal to or greater than the threshold value.

3. The voice processing system according to claim 1, wherein
the one or more processors output the first voice having a shortest delay time from among the plurality of voices to the voice processing unit in a case where the degree of similarity among the plurality of voices is equal to or greater than the threshold value.

4. The voice processing system according to claim 1, wherein
the one or more processors output the plurality of voices to the voice processing unit in a case where the degree of similarity among the plurality of voices is less than the threshold value.

5. The voice processing system according to claim 1, wherein
the one or more processors compare waveforms of the respective plurality of voices and determine a degree of similarity.

6. The voice processing system according to claim 1, wherein
the one or more processors execute at least one of voice conversion processing of converting the voice into text information or voice synthesis processing of synthesizing the voice.

7. The voice processing system according to claim 1, wherein
the one or more processors:
converts the first voice into text information in a case where the degree of similarity among the plurality of voices is equal to or greater than the threshold value and
converts each of the plurality of voices into text information in a case where the degree of similarity among the plurality of voices is less than the threshold value.

8. The voice processing system according to claim 6, wherein
in a case where the degree of similarity among the plurality of voices is less than the threshold value, the one or more processors output a predetermined number of voices from among the plurality of voices to a voice processing unit that executes the voice conversion processing and output the plurality of voices to a voice processing unit that executes the voice synthesis processing.

9. A voice processing method executed by one or plurality of processors, the voice processing method comprising:
acquiring voices uttered by users and input to respective microphones of a plurality of audio devices arranged in the same space;
determining a degree of similarity among a respective plurality of voices acquired from the plurality of audio devices;
outputting a specific first voice from among the plurality of voices to a voice processing unit in a case where the degree of similarity among the plurality of voices is equal to or greater than a threshold value.

10. A non-transitory computer-readable recording medium in which a voice processing program is recorded, the voice processing program causing one or more processors to:
acquire voices uttered by users and input to respective microphones of a plurality of audio devices arranged in the same space;
determine a degree of similarity among a respective plurality of voices acquired from the plurality of audio devices; and
output a specific first voice from among the plurality of voices to a voice processing unit in a case where the degree of similarity among the plurality of voices is equal to or greater than a threshold value.
